(19) United States
(12) Patent Application Publication
(10) Pub. No.: US 2002/0107610 A1
(43) Pub. Date: Aug. 8, 2002

(54) Special product vending system and method

(76) Inventors: David L. Kaehler, Greensboro, NC (US); Joseph Long, Greensboro, NC (US)

Correspondence Address: WITHROW & TERRANOVA, P.L.L.C., P.O. BOX 1287, CARY, NC, 27512, US

(21) Appl. No.: 09/779,089

(22) Filed: Feb. 8, 2001

(51) Int. Cl. G06F 17/00

(52) U.S. Cl. 700/232; 700/237

(57) ABSTRACT

A remote transaction station for the automated vending of goods and services sell products, and additionally dispenses at random special products, packaged in the size and shape of vended products but containing promotional prizes. When a special product is dispensed, the selected product is additionally dispensed, without the need to engage in a separate transaction. In one embodiment, special products are interspersed with products in the remote transaction station's inventory, and the dispensing of a special product is detected by an optical, RF, or other detector, prompting the subsequent dispensing of the selected product. In another embodiment, the products and special products are stored in separate inventories, and a special product is dispensed on command based on a pseudo-random number generator in an associated controller. In another embodiment, the remote transaction station is an information kiosk vending digital products. Dispensing of a special product is pseudo-randomly determined and the special product is selected from among available products.

### FIELD OF THE INVENTION

The present invention relates to a remote transaction station operative to dispense special vending products at random, and to recognize such products to additionally vend to the customer the selected product.

### BACKGROUND OF THE INVENTION

“Free” has often been described as the most powerfull word in advertising. The promise of a free gift with a purchase is widely used to boost sales in a broad category of goods and services. Similarly, even the promise of a chance at a free prize is a powerful inducement for consumers, and hence an effective marketing strategy.

Remote transaction stations, such as for example vending machines, are widely used to sell goods and services to consumers. Remote transaction stations are well known in the art, and their basic operation is familiar to most consumers. Typically, a remote transaction station contains an inventory of products stored in a suitable environment (for example, carbonated beverage dispensers are typically refrigerated, ice cream dispensers include a freezer, etc.). The remote transaction station generally contains: (1) some indication of its products and their prices; (2) a device for accepting cash or other form of payment; (3) an input mechanism for the consumer to select from among the products vended; (4) optionally some output whereby a dialog or interaction with the consumer is enabled; and (5) a method of delivering the purchased product to the consumer. In a typical transaction, a consumer approaches the remote transaction station, reviews the goods available and their associated prices, inserts money or other form of payment, and selects a desired product. If the payment is approved and the selected product is within the inventory of the remote transaction station, one item of the selected product is dispensed to the customer.

To enhance sales through remote transaction stations, various promotional programs are employed. For example, a subset of the products dispensed by the remote transaction station may contain some particular code, slogan, or other indicia in a location accessible by the consumer but hidden from view before the product is accessed (for example, on the interior surface of a bottle cap or can pop-top, printed on the inside of a label attached to the product, or the like). The lucky consumer submits his indicia of winning to the product manufacturer or his representative, and redeems his prize. While these promotions are effective to increase sales among certain segments of consumers, they do not interest other consumers due to the perceived low odds of winning, the delay between discovery of a winning indicia and redemption of the free prize, or a lack of interest in the particular prize that is offered.

A promotional campaign more effective with some consumers is the promise of a free prize or chance at a free prize that is immediately accessible. It is known in the art to randomly distribute prizes among the inventory of products in a remote transaction station, thus randomly dispensing a prize in lieu of the product that the consumer selected. Since the prize dispensed is generally much more valuable than the selected product which is not dispensed, consumers are generally not irritated at receiving the prize. However, they must still purchase another item to receive the product that they originally selected and attempted to purchase. One solution to this drawback is disclosed in U.S. Pat. No. 5,924,596, issued to Mark Kaufman on Jul. 20, 1999. The Kaufman patent discloses a promotional prize, such as for example a t-shirt, compressed and formed into the general size and shape of the dispensed product, such as a soda can. The prize is maintained in the size and shape of the product by a plastic covering, such as “shrink wrap,” or alternatively may be placed inside an empty container of the appropriate size and shape. The prizes are randomly distributed throughout the inventory of a remote transaction station, and thus a consumer may at random receive a prize in lieu of a can of soda. The Kaufinan patent discloses the insertion of sufficient coins or tokens within the dispensed prize to purchase another item of the customer's selected product.

This solution still has certain significant drawbacks, however. To obtain the desired product, the customer must engage in an entirely separate transaction with the vending machine. The customer may be in a hurry, or simply annoyed at the necessity of engaging in a transaction twice to obtain his desired product. Furthermore, the prize must be opened and the promotional article extracted and unfolded to access the coins contained in the prize. During this process, the coins or tokens may be dropped or lost, and if the customer otherwise lacks sufficient change he may be deprived of the product which he selected. Also, the customer may not have sufficient time to open the prize package and inspect its contents to retrieve the coins contained therein, or he may be in a line of other customers waiting to access the vending machine, generating ill will and causing delays.

### SUMMARY OF THE INVENTION

The present invention entails a remote transaction station containing an inventory of products and at least one special product. The remote transaction station dispenses a special product at random to a customer, and vends a product selected by the customer in the same transaction.

In one embodiment, the special product is dispensed first in lieu of the customer's selected product. The remote transaction station detects the dispensing of the special product, and subsequently dispenses the selected product if the selected product is available in inventory. Dispensing of the special product is detected by a detector positioned to cover the path of product travel. The detector may operate by optical recognition, radio frequency interrogation, magnetic marker detection, sonic detection, reactive coupling, or ferrous metal detection via an oscillator.

In another embodiment, the remote transaction station stores products and special products in separate inventories. A special product is dispensed to a customer under the control of a controller such as a digital microprocessor. The special product may be dispensed at random, based on a pseudo-random number generator in the controller, or alternatively the decision to dispense a special product may be influenced by marketing factors, such as the mode of a customer's payment.

In another embodiment, the remote transaction station comprises an information kiosk, vending information products such as digital music or video files, and/or news, weather, sports, and the like. Time-critical or heavily accessed information may be stored in an inventory local to the remote transaction station; other information products may be accessed by the remote transaction station via a telecommunications link on an as-ordered basis. A special product may be dispensed by the remote transaction station based on a pseudo-random number generator in an on-board controller, based on the information products ordered by the customer, or other marketing factors. A customer may be prompted to select a special product from a limited list of products.

### BRIEF DESCRIPTION OF THE DRAWINGS

FIG. 1 depicts a remote transaction station with products and special products commingled in a single inventory;

FIG. 2 is a functional block diagram of the remote transaction station of FIG. 1;

FIG. 3 is a flowchart depicting the operation of the remote transaction station of FIG. 1;

FIG. 4 depicts a remote transaction station with products and special products stored in separate inventories;

FIG. 5 is a functional block diagram of the remote transaction station of FIG. 4;

FIG. 6 is a flowchart depicting the operation of the remote transaction station of FIG. 4;

FIG. 7 depicts a remote transaction station with products and special products commingled in local and remote inventories;

FIG. 8 is a functional block diagram of the remote transaction station of FIG. 7; and

FIG. 9 is a flowchart depicting the operation of the remote transaction station of FIG. 7.

### DETAILED DESCRIPTION OF THE INVENTION

A remote transaction station is an automated point-of-sale (POS) system equipped and operative for interaction with consumers to facilitate the purchase of goods and/or services. As used herein, the term “remote transaction station” is broadly defined. A remote transaction station may, for example, comprise a traditional vending machine, operative to automatically vend a wide variety of goods such as hot or cold beverages; candy, gum, snacks or other food products; incidentals (e.g., a comb, toothbrush, or the like) or other consumer goods. Such remote transaction stations may vend products from gravity-fed chutes, from horizontal trays via the rotation of helical actuators, from compartmentalized containers rotated to coincide with an access door, through fluid tubes into a cup, or via a wide variety of other configurations, as are well known in the art. The products vended may be purchased as consumer goods, or rented, such as videotapes, entertainment system games, or the like. One such device is described in PCT Patent Application WO 96/06415, Method and Apparatus for Vending Goods in Conjunction with a Credit Card Accepting Fuel Dispensing Pump,” the disclosure of which is incorporated herein by reference in its entirety.

Alternatively or additionally, the goods purchased, leased, or licensed from a remote transaction station may comprise information, data, computer programs, or entertainment in electronic form. Examples include news reports, weather forecasts, and music, video, or other content in electronic format, which the user may order and purchase, lease, or license at the remote transaction station. Such information may additionally be downloaded directly into the user's automotive computer, handheld computing device, musical playback device, or the like.

Services may be vended through a remote transaction station, such as for example purchasing a car wash, placing a telephone call, ordering a pay-per-view movie, etc. As illustrative examples, the following pending patent applications are incorporated herein by reference in their entirety: Ser. No. 09/483,074, “Multistage Data Purchase,” describing a remote transaction station for the delivery of information purchased over a computer network; Ser. No. 09/482,281, “Multistage Forecourt Data Order and/or Purchase,” describing the order and purchase of a variety of goods and services through a remote transaction station in a fueling environment; and Ser. No. 09/483,079, “Retailing Audio Files in a Fuel Dispensing Environment,” describing the order and purchase of music through a remote transaction station in a fueling environment. In general, any type of goods and/or services (hereinafter collectively referred to as “products”) may be ordered and purchased through a remote transaction station; the above examples are illustrative only, and not limiting.

Vending Machine

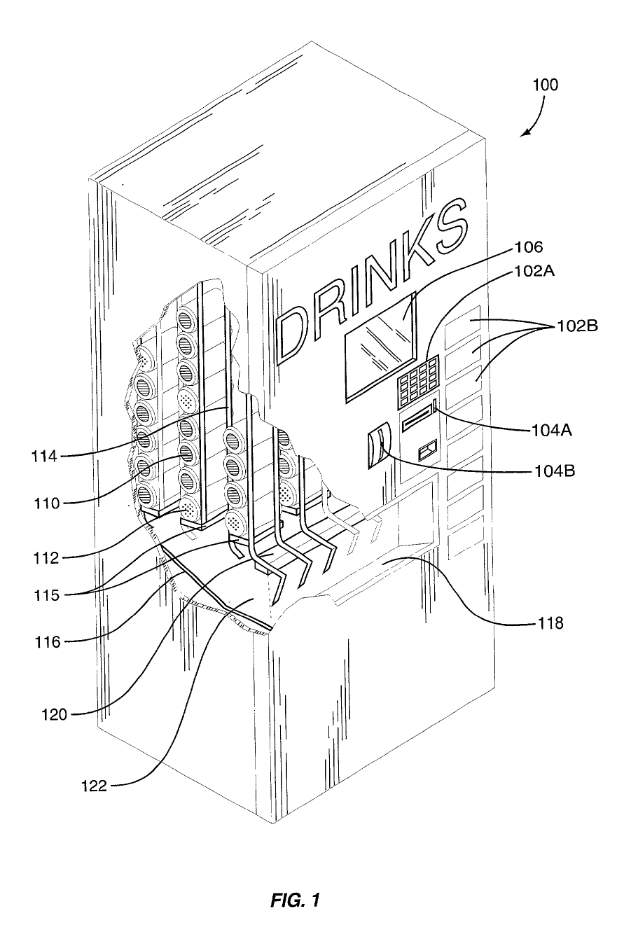

FIG. 1 depicts a remote transaction station 100 according to one exemplary embodiment of the present invention, in the form of a beverage vending machine, indicated generally by the numeral 100. Remote transaction station 100 is a self-contained, fully automated retail transaction processing and product dispensing POS system.

Remote transaction station 100 requires certain communication with the customer to effect the vending of products. At a minimum, these communications comprise product selection (if more than one product is offered by remote transaction station 100) and payment for the product. These communications may be accomplished as simply as the well-known product selection buttons and coin acceptor. Additionally, however, they may comprise a wide variety of technologies that enable a rich dialogue between remote transaction station 100 and the customer. Interface and communications technologies are discussed herein under the broad categories of input, payment, and output.

Remote transaction station 100 contains an input device or devices 102 functional to establish consumer communication with the remote transaction station 100 for the selection of desired goods and services. Input device 102 may comprise a mechanism requiring tactile contact by the consumer, for example a keyboard, keypad, touchscreen, or programmable function keys. Alternatively, input device 102 may be of a form that requires no physical contact, such as a transponder or other wireless communication, a smart card, speech recognition, or a direct link to a secondary device such as a PDA or laptop computer. In one embodiment, as depicted in FIG. 1, remote transaction station 100 contains keypad 102A and product selection buttons 102B, facilitating customer selection from among the variety of beverages available.

Remote transaction station 100 may also contain one or more payment devices 104 for allowing the customer to pay for his purchases. This may be done directly, for example with a cash acceptor operative to accept and verify currency and coins. Alternatively, payment device 104 may be effective to identify a credit or cash account number. For example, payment device 104 may comprise a magnetic stripe card reader, a transponder effective to receive an account number wirelessly, or a smart card reader. An illustrative example of a transponder payment device is disclosed in U.S. Pat. No. 6,073,840, “Fuel Dispensing and Retail System Providing for Transponder Prepayment,” the disclosure of which is incorporated herein by reference in its entirety. Payment device 104 may alternatively comprise an optical reader effective to detect interpretive visual indicia such as a bar code. An illustrative example of a bar code reader payment device is disclosed in U.S. Pat. No. 6,062,473, “Energy Dispensing System Having a Bar Code Scanning Unit,” the disclosure of which is incorporated herein in its entirety. Additionally or alternatively, payment device 104 may be effective to recognize the consumer, either to thereby associate an account number with the consumer or as a security measure to validate an account number otherwise received. This may comprise, for example, a camera and associated facial recognition system. As an example of a remote transaction station having a camera incorporated therein, the disclosure of U.S. Pat. No. 6,032,126, “Audio and Audio/Video Operator Intercom for a Fuel Dispenser” is incorporated herein in its entirety. Alternatively, a payment device 104 with customer recognition may include a biometric sensor, for example, a camera effective to detect and interpret eye iris patterns, a fingerprint detector, or the like. In the embodiment depicted in FIG. 1, remote transaction station 100 includes a cash acceptor 104A and a magnetic stripe card reader 104B, to facilitate payment for the products vended.

The remote transaction station 100 may additionally include an output device 106 to facilitate communication with the customer. Output device 106 may present the customer with instructions, various menus or other selections of goods and/or services available for purchase, and may additionally present entertainment content and/or advertising. Output device 106 may comprise a text or graphic output display that may be of any technology or type known in the art, illustratively including any of a variety of liquid crystal displays (LCD), both Passive Matrix (PMLCD) and Active Matrix (AMLCD)—including Thin-Film Transistor (TFT-LCD), Diode Matrix, Metal-Insulator Metal (MIM), Active-Addressed LCD, Plasma-Addressed Liquid Crystal (PALC), or Ferroelectric Liquid Crystal Display (FLCD). Alternatively, the display may comprise Plasma Display Panel (PDP), Electroluminescent Display (EL), Field Emission Display (FED), Vacuum Fluorescent Displays (VFD), Digital Micromirror Devices (DMD), Light Emitting Diodes (LED), Electrochromic Display, Light Emitting Polymers, video display (cathode ray tube or projection), holographic projection, etc. Output device 106 may additionally comprise input functions, such as a touch screen display, whereby tactile input from the customer on the screen proximate to a displayed indicia is interpreted as a selection of a product, menu step, or action associated with the indicia. The display technologies discussed above are illustrative in nature, and not intended to be limiting. In the embodiment depicted in FIG. 1, remote transaction station 100 contains display 106 for outputting menus, instructions, advertising messages, and the like to the customer.

Alternatively or additionally, output device 106 may be audible. Output device 106 may also provide for the actual delivery of goods in electronic form. This may be accomplished through communication to a secondary device, such as a computer in the consume's automobile, a PDA or laptop computer, a mobile telephone terminal, a musical playback device, or the like. Connection to the secondary device may be through a wired connection, as through a plug provided on the remote transaction station 100, or over a wireless radio frequency or optical connection.

Product selection, payment, and output functions may be combined in sophisticated communications interfaces. For example, remote transaction station 100 may include a telephonic interface, allowing the customer to communicate via a mobile radiocommunication terminal. As used herein, a mobile radio communication terminal may comprise a cellular radiotelephone; a Personal Communications Service (PCS) terminal that combines a cellular radiotelephone with data processing capabilities; a Personal Digital Assistant (PDA) that may include a radiotelephone; or a conventional laptop computer, a palmtop computer, or other appliance that includes a radiotelephone transceiver. The mobile radiocommunication terminal may employ a wide variety of communication standards and protocols, which are published by organizations such as the Telecommunications Industry Association/Electronics Industry Association (TIA/EIA) and the European Telecommunication Standards Institute (ETSI).

Another example of a sophisticated communications interface combining input, payment, and output functions is a short-range wireless network such as the BLUETOOTH® interface designed and promulgated by Ericsson, Inc. BLUETOOTH® is a universal radio interface in the 2.45 GHz frequency band that enables portable electronic devices to connect and communicate wirelessly via short-range, ad hoc networks. Persons interested in various details regarding the Bluetooth technology are referred to the article entitled “The Bluetooth Radio System” by Jaap Haartsen, published in the IEEE Personal Communications, February, 2000, the disclosure of which is incorporated herein by reference.

As shown in the cutaway view in FIG. 1, remote transaction station 100 contains an inventory of products 110 (in this embodiment, cans containing beverages). The products 110 are arranged in racks within the interior of remote transaction station 100, which may be refrigerated. Interspersed among products 110 in the inventory of remote transaction station 100 are special products 112. Special products 112 are packaged to conform to the same general size and shape as products 110. Special products 112 may comprise prizes, such as t-shirts, sunglasses, wristwatches, or similar promotional items, and/or may include tokens or receipts redeemable through other channels for additional prizes that are not readily packaged in the size and shape of a beverage can.

As shown in FIG. 1, products 110 and special products 112 are arranged in racks 114. Upon payment and selection of product 110 by a customer, product 110 or special product 112 is dispensed from a rack 114 by operation of an actuator 115. The product 110 or special product 112 falls by operation of gravity onto ramp 116, where it proceeds to dispensing tray 118, and is retrieved by the customer.

Since special products 112 are dispersed among products 110 in the inventory of remote transaction station 100 at random, special product 112 may be randomly dispensed to any given customer upon any given transaction, in lieu of product 110 that the customer purchased. Since the value of special products 112 is generally much greater than the value of products 110, customers are generally pleased to receive a special product 112. The present invention also subsequently dispenses product 110 to the customer without the necessity of engaging in a separate transaction.

To achieve this, remote transaction station 100 detects the dispensing of a special product 112. This is accomplished by a detector 120. Detector 120 is mounted within the remote transaction station 100 over the product dispensing ramp 116, or in another suitable location, where it is effective to scan products 110 and special products 112 dispensed from the merged inventory in remote transaction station 100. As shown in FIG. 1, detector 120 has a “zone” of operation 122, i.e., an area in which the detector 120 is operative to detect special products 112 passing through the zone 122.

Detector 120 may comprise an optical detector, with corresponding optical indicia on the products 110, special products 112, or both. For example, detector 120 may comprise a bar code scanner/reader, with corresponding bar codes placed on the products 110, 112. In this case, detection zone 122 would comprise an area that is scanned by a laser or other light source. A bar code is a series of varying width dark lines, called bars, separated by light spaces. Different combinations of the bars and spaces represent different characters or other data. When special product 112 passes through the bar code scanner detection zone 122, the light emanating from detector 120 is absorbed by the dark bars in the bar code and not reflected, but it is reflected by the light spaces. A photocell detector in detector 120 receives the reflected light and converts the light into an electrical signal. As the optical source passes over the bar code, detector 120 creates, for example, a low electrical signal for the spaces (reflected light) and a high electrical signal for the bars (nothing is reflected); the duration of the electrical signal determines wide vs. narrow elements. This signal is then decoded by detector 120 into the characters that the bar code represents. The decoded data may then be passed to controller 130. Special products 112 alone could be supplied with bar codes, so that any bar code detected would indicate the presence of a special product 112. Alternatively, products 110 could be supplied with bar codes, with no bar codes on special products 112. The presence of special product 112 would then be indicated by the absence of a signal from detector 120. As another alternative, both products 110 and special products 112 could be supplied with bar codes, with each encoded differently. Detector 120 (or alternatively, the controller 130) would then determine which type product has been dispensed by the decoded data. In any of these cases, the bar codes may be encoded according to any encoding standard, including but not limited to Code 11, Codabar, Plessey, MSI, Interleaved 2 of 5, UPC, EAN, Code 39, Code 128, or Code 93. Depending on the size and shape of products 110, 112 and the method of product delivery in remote transaction station 100, a plurality of bar codes may be required around the periphery of the products 110, 112, to ensure that at least one bar code is readable by detector 120 while products 110, 112 are in the scanning zone 122.

Alternatively, detector 120 may comprise a radio frequency identification (RFID) interrogator/reader, with corresponding RFID transponders or “tags” located in or on special products 112. RFID reader 120 may output a single frequency RF signal, with each RFID tag, via a response signal, responding by communicating an identification code. In this configuration, RFID reader 120 generates an RF sine wave that provides power to the RFID tags, a synchronized clock source to the RFID tags, and functions as a carrier for returned data from RFID tags. This RF electromagnetic field would be present in the zone 122 depicted in FIG. 1. Each RFID tag in special product 112 contains a coil antenna. The time-varying magnetic field of the electromagnetic output of RFID reader 120 induces an AC voltage in the coil antenna of the RFID tag as the special product 112 passes through the detection zone 122. This voltage is rectified by electronics in the RFID tag, and powers a silicone memory chip and associated logic. Once the RFID tag has received sufficient energy from its coil antenna to operate correctly, it divides down the RF carrier signal and begins clocking its data to an output transistor connected across the coil antenna. The output transistor shunts the coil sequentially, corresponding to the data being clocked out of the memory array. Shunting the coil causes a momentary fluctuation of the carrier signal, which is detected by the RFID reader 120. In this manner, commonly referred to as “backscatter modulation,” each RFID tag communicates its identification number or code to the RFID reader 120. The codes in RFID tags in special products 112 may be unique, or they may all be identical. Alternatively, products 110 and special products 112 may each contain RFID tags, with the tags transmitting different identification codes. Passive RFID systems are well known in the art. For further explanation, one is directed to “Passive RFID Basics” by Pete Sorrells, publication DS00618A of Microchip Technology Inc., the disclosure of which is incorporated herein in its entirety. Furthermore, the detector 120 may comprise an RFID system wherein the RFID tags are active (i.e., contain an independent power source such as a battery), respond on different frequencies, or according to a broad array of RFID technology as is well known in the art.

Alternatively, detector 120 may comprise a magnetic marker detector. Magnetic coupling technologies are employed in Electromagnetic Article Surveillance (EAS) systems commonly used for anti-theft control of books in libraries, CDs in stores, and the like. In such EAS systems, an alternating magnetic field is applied within an interrogation zone and the presence of a ferromagnetic marker within the zone is detected based on signals produced by the marker in response to the applied field. As the magnetic field alternates, the magnetization of the marker material reverses. Each magnetization reversal produces a pulse of external polar magnetic field, which can be detected. Furthermore, dual status markers have been developed wherein the marker may be selectively placed in a sensitized state (i.e., will respond to an alternating magnetic field and is thus detectable) or a desensitized state (i.e., the marker does not reverse its magnetization under the alternating field and thus is not detectable). To place a marker in a desensitized state, remanently magnetizable control element is added, and is remanently magnetized to a polarization. The control element's magnetic field is sufficient to oppose the effects of the alternating magnetic field. By demagnetizing the control element, the marker is again placed in a sensitized state. Magnetic coupled markers are described in U.S. Pat. No. 3,665,449 to Elder et al., entitled “Method and Apparatus for the Detecting at a Distance the Status and Identity of Objects,” the disclosure of which is incorporated herein in its entirety. As an example, a magnetic strip and detection system utilizing this technology is available from 3M of St. Paul, Minn., and is sold under the product name TATTLE TAPE.® Magnetic markers placed in or on special products 112 and placed in a sensitized state would be detected by the detector 120 as the special product 112 passed through the alternating magnetic field 122. Alternatively, both products 100 and special products 112 could be supplied with magnetic markers, with one sensitized and the other desensitized.

Detector 120 may comprise a tuned oscillator and associated circuitry, the resonant frequency of which is altered by the presence of ferrous material in its radiation zone 122. Other examples include sonic detectors, inductive or capacitive coupling detectors, and other technologies as are well known in the art.

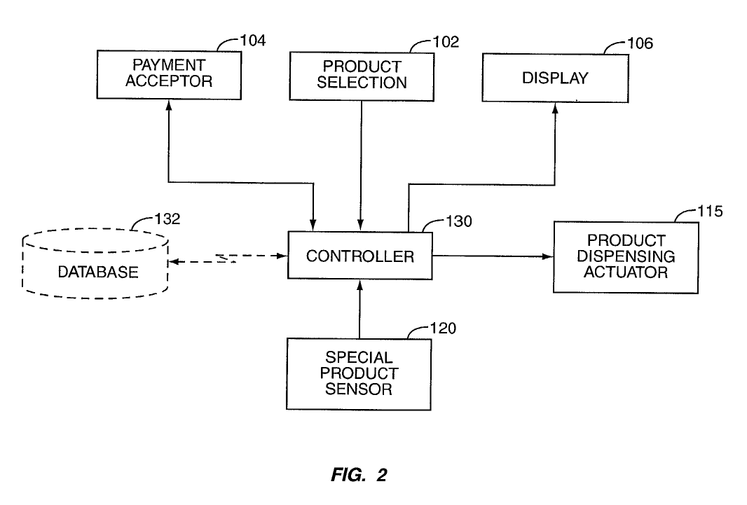

FIG. 2 depicts a functional block diagram of one embodiment of remote transaction station 100 of FIG. 1. Remote transaction station 100 contains a controller 130 for controlling all aspects of the customer interface and the dispensing of products 110 and special products 112. Controller 130 may comprise a digital microprocessor or microcontroller, with the attendant memory, programmed control software, clock source, power supply, and the like, as necessary or suitable, and as are well known in the art. Controller 130 interfaces to and controls the operation of payment acceptor 104. As described herein above, payment acceptor 104 may comprise a broad array of technologies. Controller 130 additionally receives input from product selection means 102, and controls and provides content for output display 106, both of which are fully described herein above. Upon receiving payment and responsive to the customer's product selection, controller 130 signals product dispensing actuator 115 to dispense a product 110 to the customer. Special product detector 120 senses the dispensing of a special product 112, and signals controller 130 that special product 112 has been dispensed. In the broad practice of the present invention, controller 130 may additionally be connected via a telecommunications link to a database 132, to effectuate credit card financial transactions, for remote inventory monitoring, maintenance and/or diagnostics, and the like.

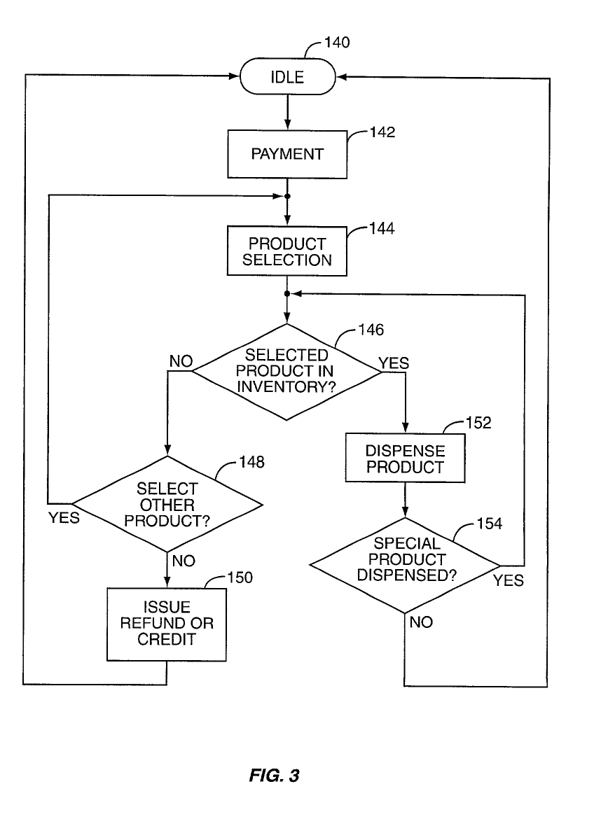

The operation of remote transaction station 100 of FIGS. 1 and 2 is described with reference to FIG. 3. Remote transaction 100 exits an idle state (step 140) upon the detection of payment by the customer (step 142), which may comprise inserting coins or cash into a cash acceptor, swiping a credit card through a card reader, or the like. The customer then makes a product selection (step 144) by actuating product selection buttons, selecting a product on a touch screen display, or the like. Remote transaction station 100 then determines if the selected product is within its inventory and available for vending (decision 46). If the selected product is not available, the customer is prompted to select an alternative product (decisionl48). If this is agreeable to the customer, control returns to product selection (step 144). If the customer does not agree to an alternative product, remote transaction station 100 issues a refund or credit (step 150) and returns to the idle state (step 140) to await input from another customer. If the selected product is in the inventory of remote transaction station 100 (decisionl46), a product is dispensed from the corresponding rack 114 (step 152). On its way to the customer, this product passes within the detection zone 122 of special product detector 120. If a special product 112 is not detected (decisionl54), then a product 110 was vended to the customer and remote transaction station 100 returns to an idle state 140 to await the next customer. If, however, a special product 112 was dispensed (decisionl54), then according to the present invention the customer will be vended his selected product 110, and control returns to the point following the customer's product selection (step 144). Normally, at this point a product 110, of the type selected by the customer, is dispensed (step 152), and the transaction is completed. If, however, the next product were also a special product 112, yet another product 110 would then be dispensed from remote transaction station 100. This process will continue until the customer is either vended his originally selected product 110, or until the rack 114 corresponding to the selected product 110 is empty. In this case, the customer will be prompted to select another product 110 (decisionl 48) and, if acceptable, will be vended that alternative product 110. If a special product 112 is dispensed in lieu of the alternative selection product 110, another alternative selected product 110 will be dispensed. Thus, the transaction will always terminate with the dispensing of a selected product 110, an alternative selected product 110, or a refund or credit.

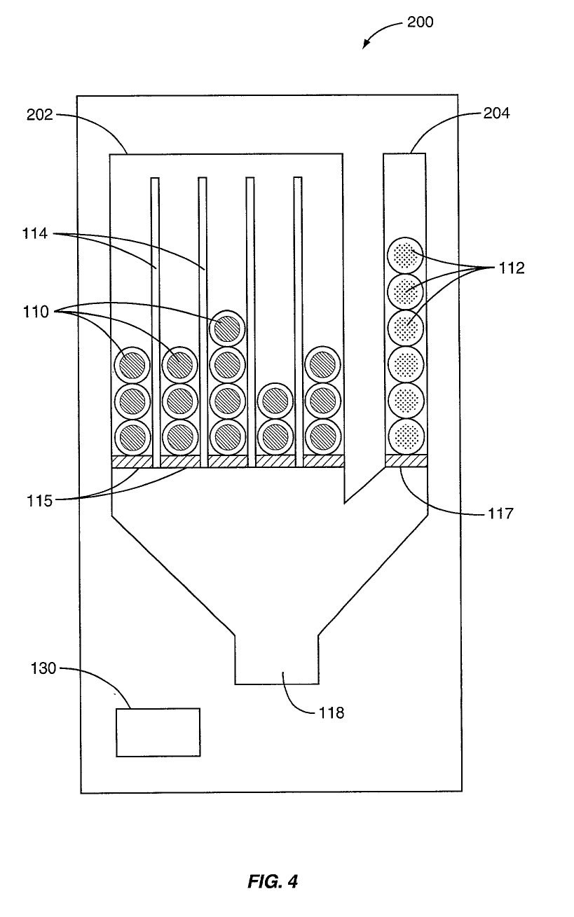

FIG. 4 depicts a diagrammatic view of an alternative exemplary embodiment of the present invention, indicated generally by the numeral 200. Remote transaction station 200 is a fully functional, self-contained, automated POS system for the vending of products 110—in this embodiment, cans of beverage. Remote transaction station 200 is similar in many respects to remote transaction station 100 described above. It includes an analogous customer interface, including customer selection input 102, payment acceptor 104, and output device 106. Remote transaction station 200 is unique, however, in its storage and dispensing of products 110 and special products 112.

FIG. 4 depicts the internal organization and storage of an inventory of products 110 and special products 112. Products 110 are stored in a relatively large inventory 202, in separate racks 114, segregated by product type. Inventory 202 may be refrigerated. An actuator 115 located at the bottom of each rack is operative to dispense a single product 110 into a chute leading to customer dispensing tray 118, responsive to commands from a controller 130.

Special products 112 are maintained in a separate and generally smaller inventory 204. Special products 112 are dispensed into a chute leading to customer dispensing tray 118 by operation of actuator 117, responsive to commands from controller 130. Thus, in remote transaction station 200, the inventories of products 110, 112 are not commingled, but are maintained separately.

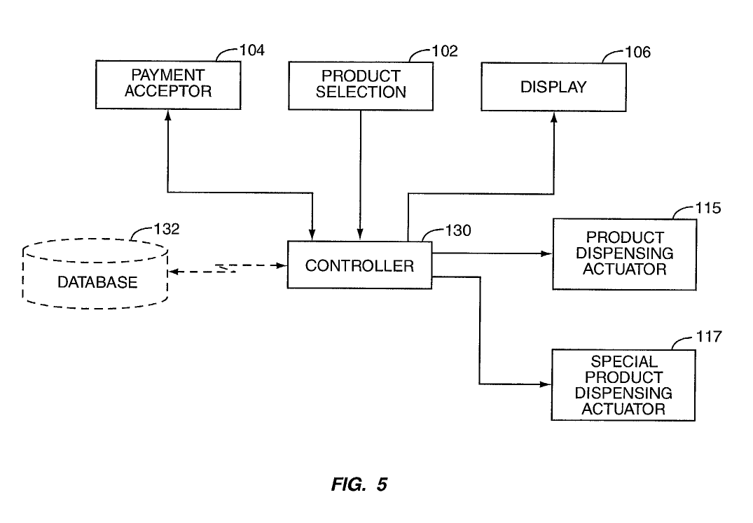

A functional block diagram of remote transaction station 200 is depicted in FIG. 5. A central controller 130 controls the customer interface and all aspects of transactions vending products to customers. Controller 130 may comprise a digital microprocessor or microcontroller and its attendant hardware and software.

Controller 130 controls the customer interface, comprising a payment acceptor 104, product selection system 102, and output display 106. Controller 130 additionally controls the operation of product dispensing actuators 115 and special product dispensing actuator 117. Controller 130 may additionally optionally be connected via a telecommunications link to a remote database 132, for the processing of various transactions and for maintenance functions.

In addition to its functions of controlling the user interface and the dispensing of products 110 and special products 112, controller 130 of remote transaction station 200 includes a pseudo-random number generator, or other suitable means for determining when to dispense special products 112. The pseudo-random number generator may comprise software executed by controller 130. Operation of the pseudo-random number generator may be influenced by various factors. For example, in an embodiment in which payment acceptor 104 comprises a communications link to a mobile radiocommunication terminal, the pseudo-random number generator may use a unique identification broadcast by the mobile terminal as a seed. Additionally, or alternatively, the fact that a mobile terminal has been utilized to effect product selection and/or payment may alter the parameters of the pseudo-random number generator, such as for example increasing the odds of a special product 112 being dispensed. In general, the decision of when to selectively dispense a special product 112 from remote transaction station 200 may be influenced by a wide variety of factors, and may be tailored to further a wide variety of marketing goals.

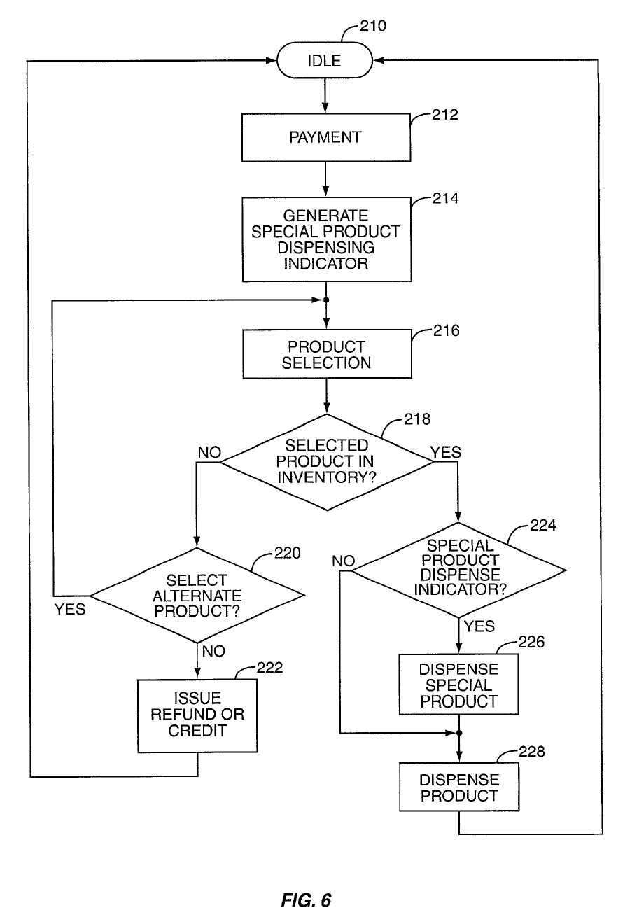

FIG. 6 depicts the operation of remote transaction station 200, according to one exemplary embodiment thereof. Remote transaction station 200 leaves the idle state (step 210) upon payment by a customer (step 212), such as for example the depositing of cash into a cash acceptor or swiping a magnetic card through a card reader. Controller 130 then generates a special product dispensing indicator (step 214). As described above, this indicator may be derived from a pseudo-random number generator, which itself may be constrained by various parameters. The special product dispensing indicator is a state in controller 130 (i.e., a flag in memory or the level of an output signal) that indicates whether or not a special product 112 is to be dispensed along with a selected product 110 as part of the current transaction. If remote transaction station 200 offers a plurality of products to the customer, the customer inputs his selection (step 216). Remote transaction station 200 determines whether any product 110 of the customer's selection resides in inventory 202 (decision 218). If not, the customer is prompted to make an alternate product selection (decision 220). If this is amenable to the customer, an alternate product 110 is selected (step 216). Note that the special product dispensing indicator does not change as a result of the customer selecting an alternate product 110. If the customer does not agree to an alternate product 110 from the one originally selected, the remote transaction station 200 issues a refund or credit to the customer (step 222).

If alternate product 110 selected is in inventory 202 (decision 218), the special product dispensing indicator is checked (decision 224). If so indicated, a special product 112 is dispensed to the customer (step 226). Immediately following, or if a special product 112 is not dispensed, the customer's selected product 110 is dispensed (step 228), and remote transaction station 200 returns to the idle state to await the next customer. It is preferable that special product 112, if any, be dispensed to the customer prior to the dispensing of his selected product 110. This ensures that the customer receives special product 112, and that he does not merely retrieve his purchased product 110 and walk away prior to the delivery of the special product 112. However, it is within the scope of the present invention to dispense the selected product 110 prior to dispensing the special product 112, or alternatively dispensing both the selected product 110 and special product 112 generally simultaneously. In any case, the customer is not required to engage in a separate transaction with remote transaction station 200 to obtain his selected product 110.

Kiosk

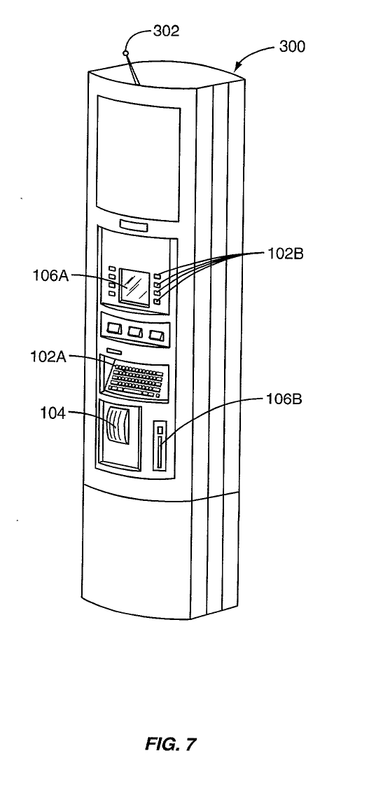

FIG. 7 depicts a remote transaction station according to another exemplary embodiment of the present invention, indicated generally by the numeral 300. Remote transaction station 300 is also known as a “kiosk.” Products 110B (not shown) dispensed by remote transaction station 300 may comprise tangible goods or information, such as for example news, weather, sports, digital music, movies, games, World Wide Web access, and the like. Remote transaction station 300 is a fully functional, stand-alone POS device for the sale and delivery of information products 110. Remote transaction station 300 contains a rich user interface, including a keyboard 102A and programmable function keys 102B for customer input, a card reader 104 for payment acceptance, display 106A and floppy disk drive 106B for output and delivery of products 110 to the customer. Additionally, remote transaction station 300 may include an antenna 302 for wireless communication with electronic devices in the customer's possession for providing an alternative user interface, payment, and/or for delivery of products 110B.

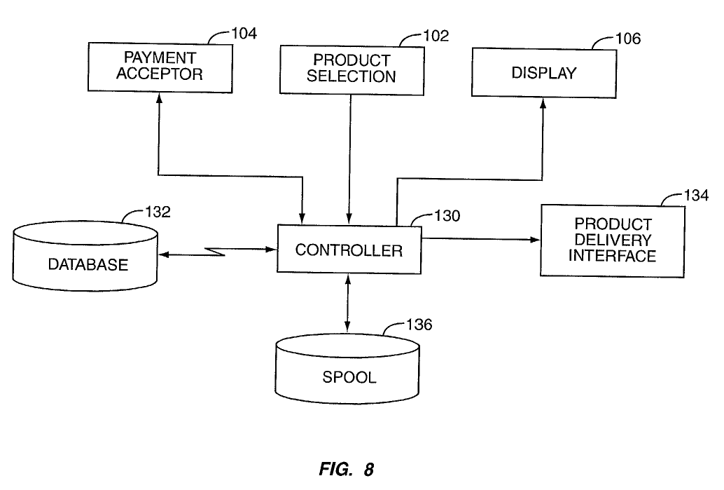

FIG. 8 depicts a functional block diagram of remote transaction station 300. Controller 130 controls the customer interface, the retrieval and delivery of information products 110 to the customer, and the optional delivery of special information products 112. As previously stated, controller 130 maybe a digital microprocessor or microcontroller, with the attendant electronics and software, as suitable and required, and is well known in the art.

The customer interface comprises product selection input 102, payment acceptor 104, and output display 106. Product selection input 102 may comprise a broad array of input technologies, as disclosed above. In particular, as depicted in FIG. 7, remote transaction station 300 may include a fully functional computer keyboard 102, complete with graphical pointer manipulation capability (i.e., mouse). Remote transaction station 300 additionally includes “soft” keys 102 adjacent output display 106. Soft keys 102, also known as programmable function keys, are dynamically allocated a meaning, based on the then-current output presented adjacent the keys on display 106. Additionally, remote transaction station 300 may include infrared input/output port 102 for wireless optical communication with, e.g., a personal computer, personal digital assistant, or the like. Also, remote transaction station 300 may contain antenna 302, electrically connected to suitable radio frequency electronics, for communication with mobile radio communication terminals, such as cell phones and the like. Payment acceptor 104 may comprise a magnetic stripe card reader, and may additionally include payment information transmitted via the wireless communication links discussed above. Output display 106 comprises a text and graphics display as is well known in the art.

Controller 130 is connected to a remote database 132 via a telecommunications link for the retrieval of certain products 110. Additionally, controller 130 is connected to a disc or spool 136 located within remote transaction station 300 for the storage and delivery of low-volume, time-critical information products 110. For example, news, weather, stock quotes, sports scores, airline flight information, and the like, may be retrieved on a regular basis from database 132 by controller 130 in a background mode, and stored on local spool 136 for immediate delivery to customers upon order.

Other information products, such as for example digital files containing music, movies, games or other entertainment content, maps, lengthy business reports, and the like may be retrieved from remote database 132 on an as-requested basis. Since customers will likely not utilize or “consume” these products 110 at remote transaction station 300, a product delivery interface 134 is provided whereby the customer may store information products 110 and take them away. The product delivery interface 134 may comprise a floppy disk drive 106, as depicted in FIG. 7, a writeable CD drive, or the like. Additionally, product delivery interface 134 may comprise a wired, wireless optical, or wireless radio frequency communication link whereby information products 110 are downloaded to an electronic device in the customer's possession.

Controller 130 additionally contains a pseudo-random number generator and associated control software for the generation of a special product dispensing indicator. The special product dispensing indicator may be derived strictly from the pseudo-random number generator, or alternatively it may additionally be influenced by the mode of the customer's communication with remote transaction station 300, by the size or makeup of the customer's order, or by a broad variety of other marketing factors.

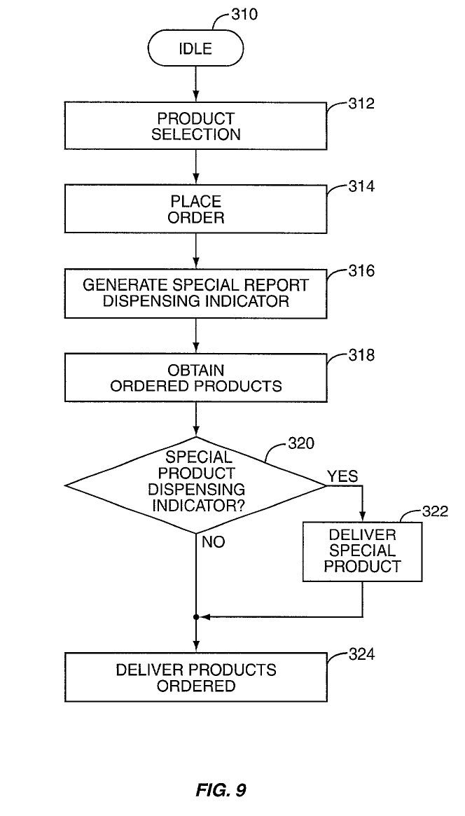

The operation of remote transaction station 300 is described with reference to FIG. 9. Remote transaction station 300 exits the idle state (step 310) upon initial input by a customer, typically accessing a product selection menu (step 312). Since the “inventory” of remote transaction station 300 is virtually unlimited via its link to remote database 132, the corresponding list of products 110 available for purchase is voluminous. Hence, the selection of a product 110 by a customer (step 312) will likely comprise an interactive dialog, such as navigating multi-level menus, composing and executing searches, and the like. When the customer has selected one or more products 110B and reviewed their prices, the customer places an order for delivery of products 110 (step 314). Payment may accompany the order immediately, such as by swiping a credit card through a card reader, or alternatively the transaction may be billed to a customer's account. At this point, and optionally based on information concerning the customer's order, controller 130 generates a special product dispensing indicator (step 316). This indicator comprises a state of controller 130, e.g., a bit or flag in memory, the level of an electrical output of controller 130, or the like. The indicator may also comprise a random number generator that randomly indicates a bit or flag or a number from which a flag, bit, or decision is derived. Remote transaction station 300 then obtains products 110 that the customer selected (step 318), and may receive special product from local spool 136 or from remote database 132, if product 110 is information. Prior to delivery of information products 110 to the customer, the state of the special product dispensing indicator is checked (decision 320). If delivery of a special product is not indicated, the products are just simply delivered to the customer (step 324). If delivery of a special product is indicated, remote transaction station 300 may additionally retrieve a pre-selected special information product 112 from its local spool 136 or from remote database 132, and include special information product 112 with customer's products 110. Alternatively, the customer may be alerted to the fact that he has won special information product 112, and be prompted to select a desired product from a limited choice list or menu. The special information products 112 are added to the customer's information products 110, and the products are delivered to the customer (step 324). As discussed above, delivery of the products may comprise immediate display of information at the remote transaction station 300, or may comprise downloading the information products 110 to an electronic device in the customer's possession.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the spirit and scope of the invention. The present embodiments are therefore to be construed in all aspects as illustrative and not restrictive and all changes coming within the meaning and equivalency range of the appended claims are intended to be embraced therein.

What is claimed is:

1. A remote transaction station, comprising:
an inventory of products; and
at least one special product;
said remote transaction station operative to dispense said at least one special product at random to a customer, and to vend a product selected by the customer in the same transaction.

2. The remote transaction station of claim 1, wherein
said at least one special product is dispensed in lieu of said selected product;
said remote transaction station detects the dispensing of said at least one special product; and
said remote transaction station subsequently dispenses said selected product if said selected product is available in said inventory.

3. The remote transaction station of claim 2, wherein if said selected product is not available in said inventory, said remote transaction station performs an action selected from the group consisting of prompting the customer to select another product and vending it, refunding the customer's purchase price, and issuing the customer a credit for the selected product.

4. The remote transaction station of claim 2, wherein said at least one special product is randomly distributed within said inventory of said remote transaction station.

5. The remote transaction station of claim 2, further comprising an optical detector operative to detect and identify an optical indicia on said at least one special product.

6. The remote transaction station of claim 2, further comprising a radio frequency receiver operative to detect and identify a radio frequency signature produced by said at least one special product.

7. The remote transaction station of claim 6, wherein said at least one special product contains an active radio frequency transmitter producing said radio frequency signature.

8. The remote transaction station of claim 6,
wherein said radio frequency receiver additionally comprises a radio frequency interrogator, and
wherein said at least one special product contains a passive radio frequency transceiver producing said radio frequency signature responsive to a radio frequency interrogation signal.

9. The remote transaction station of claim 2, further comprising a magnetic detector operative to detect a magnetic marker on said at least one special product.

10. The remote transaction station of claim 9, wherein said magnetic marker may be selectively set to a sensitized state wherein it is detected by said magnetic detector or a desensitized state wherein it is not detected by said magnetic detector.

11. The remote transaction station of claim 2, further comprising a sonic detector operative to detect and identify a sonic source on said at least one special product.

12. The remote transaction station of claim 2, further comprising a detector operative to detect and identify a reactive element on said at least one special product.

13. The remote transaction station of claim 12, wherein said detector operates responsive to an effect selected from the group consisting of inductive coupling and capacitive coupling.

14. The remote transaction station of claim 2, further comprising an oscillator, and wherein said at least one special product is detected by a perturbation in a frequency of said oscillator caused by said at least one special product.

15. The remote transaction station of claim 2, further comprising:
a first detector operative to detect the dispensing of either said selected product or said at least one special product; and
a second detector operative to detect the dispensing of said selected product but not the dispensing of said at least one special product; and
wherein the dispensing of said at least one special product is identified by the lack of indication from said second detector.

16. The remote transaction station of claim 15, wherein said second detector is selected from the group consisting of an optical detector, a radio frequency detector, a sonic detector, a reactive detector, and an oscillator.

17. The remote transaction station of claim 15, wherein said special product is dispensed generally simultaneously with said selected product.

18. The remote transaction station of claim 17, wherein said at least one special product is stored separately from said inventory, and is dispensed to the customer along a channel distinct from that by which said selected product is dispensed.

19. The remote transaction station of claim 18, wherein the dispensing of said at least one special product is triggered on a pseudo-random basis.

20. The remote transaction station of claim 19, further comprising a microprocessor, wherein said microprocessor is operative to generate a pseudo-random number at least at the beginning of each transaction, said pseudo-random number being operative to trigger said dispensing of said at least one special product.

21. The remote transaction station of claim 20, further comprising a wireless communication interface operative to effect a function selected from the group consisting of product selection and product payment, wherein said pseudo-random number generated by said microprocessor is related to an identification code transmitted to said remote transaction station over said wireless communication interface.

22. The remote transaction station of claim 19, wherein the odds of said at least one special product being dispensed is dependent on the method of payment for said selected product.

23. A remote transaction station for vending at least one product comprising digital data, wherein at least one special product comprising digital data is additionally dispensed at random with a selected product, in the same transaction.

24. The remote transaction station of claim 23, wherein said product and said special product are retrieved from a location remote from said remote transaction station.

25. A system for vending products to a customer, comprising:
an inventory of products;
at least one special product;
a payment acceptance interface; and
a product dispenser operative to dispense said at least one special product at random to the customer, and to vend a product selected by the customer in the same transaction.

26. The system of claim 25, wherein said payment acceptance interface comprises a cash acceptor.

27. The system of claim 25, wherein said payment acceptance interface comprises a magnetic stripe card reader.

28. The system of claim 25, wherein said payment acceptance interface comprises an optical reader operative to operative to read an optical indicia from a card presented by the customer, that uniquely associates the customer with an account to which the purchase is charged.

29. The system of claim 25, wherein said payment acceptance interface comprises an RFID reader operative to read a transponder in the customer's possession, said transponder transmitting code to said reader that uniquely associates the customer with an account to which the purchase is charged.

30. The system of claim 25, further comprising an image capture and processing system operative to uniquely identify a customer, said customer being associated with an account to which the purchase is charged.

31. The system of claim 25, wherein said payment acceptance interface comprises a biometric sensor operative to uniquely identify a customer, said customer being associated with an account to which the purchase is charged.

32. The system of claim 25, wherein said inventory of products comprises at least two distinct products, and wherein said system further comprises a product selection interface.

33. The system of claim 32, wherein said product selection interface comprises a plurality of selection buttons, each said selection button associated with a product, and each said selection button operative to select said associated product when actuated by the customer.

34. The system of claim 32, wherein said product selection interface comprises a tactile responsive display displaying a plurality of indicia, each said indicia associated with a product, said display operative to select said associated product upon tactile input proximate each said indicia by the customer.

35. The system of claim 32, wherein said product selection interface comprises an audio input transducer operatively connected to an audio processor, said audio processor operative to interpret voice selection commands spoken by the customer.

36. The system of claim 32, wherein said product selection interface is operative to receive product selections entered by the customer on a remote device.

37. The system of claim 36, wherein said remote device comprises a mobile radiocommunication terminal.

38. The system of claim 36, wherein said product selection interface and said remote device communicate via a short-range radio frequency network interface.

39. A method of randomly dispensing a special product from a remote transaction station to a customer, comprising:
accepting payment from the customer;
if more than one product is vended, receiving a selection input from the customer selecting a product;
randomly dispensing to the customer said special product; and
vending to the customer said selected product; and
whereby if said special product is dispensed, both said special product and said selected product are dispensed to the customer in the same transaction.

40. The method of claim 39, wherein said remote transaction station comprises an inventory wherein said product and said special product are commingled, and wherein said remote transaction station further comprises a detector operative to detect said special product as it is dispensed, and wherein said transaction station subsequently dispenses said selected product when said special product is detected.

41. The method of claim 40, where in said detector is selected from the group consisting of an optical detector, a radio frequency detector, a sonic detector, a reactive detector, and an oscillator.

42. The method of claim 39, wherein said remote transaction station contains said product and said special product in separate inventories, and wherein said remote transaction station further comprises a controller operative to generate a special product dispensing signal at random, said special product dispensing signal operative to dispense said special product to the customer.

43. The method of claim 39, wherein accepting payment from the customer comprises operation of a device selected from the group consisting of cash acceptor, optical card reader, magnetic stripe card reader, RFID reader, image capture and processing system, biometric sensor, mobile radiocommunication terminal interface and short-range radio frequency network interface.

44. The method of claim 39, wherein receiving a selection input from the customer selecting a product comprises operation of a device selected from the group consisting of product selection buttons, touch-screen display, voice recognition, mobile radiocommunication terminal interface and short-range radio frequency network interface.
